(19) United States
(12) Patent Application Publication
(10) Pub. No.: US 2007/0128338 A1
(43) Pub. Date: Jun. 7, 2007

(54) Physical process causing the effect of preserving fish or meat food throughout long periods of time, tens of months, thereby preserving the properties of a fresh product

(75) Inventor: Juan Ignacio Valdes Edwards, Comuna de Providencia Santiago (CL)

Correspondence Address: MERCHANT & GOULD PC, P.O. BOX 2903, MINNEAPOLIS, MN, 55402-0903, US

(73) Assignees: Pontificia Universidad Catolica de Chile, Santiago (CL); Fundacion Serena, Comuna de Providencia Santiago (CL); Asesorias e Inversiones J.V. & A Ltda., Comuna de Providencia Santiago (CL); Jose Lucio de Araujo Correa, Jardim Paulista, Sao Paulo (BR)

(21) Appl. No.: 10/579,166

(22) PCT Filed: Nov. 12, 2004
(86) PCT No.: PCT/BR04/00223

§ 371 Date: Feb. 9, 2007

(30) Foreign Application Priority Data
Nov. 14, 2003 (CL) 2359-2003

(51) Int. Cl. A23L 1/325

(52) U.S. Cl. 426/643

(57) ABSTRACT

A physical process causing the effect of preserving fish or meat food throughout long periods of time, tens of months, thereby preserving the properties of a fresh product, such as its color, smell, texture and taste, while preserving the proteic and vitaminic contents of the original product, is revealed. In the case of fish, the process consists of the following steps: a) Capturing, eviscerating, cleaning, and washing the fish, all in an hygienic environment; b) Keeping said fish under moderate cold, using ice scales or adequate cold facilities; c) Cutting the fish in agreement with the commercial requirements to be satisfied;
d) Subjecting the fish to an initial quick freezing process reaching −5° C.; e) Packaging the product in special packages, which possess high impermeability to gases and water vapor, being flexible and adaptable while being physically resistant;
f) Subjecting the packed product to a “high vacuum” process, wherein “high vacuum” is defined as a 99% vacuum;
g) Continuing the quick freezing of the process to reach −18° C.;
h) Keeping the packed product in plastified cardboard boxes on pile-up systems, at low and uniform temperatures around −18° C.; i) Using the treated product; j) Consuming the treated product by cooking it using normal methods.

### FIELD OF THE INVENTION

The present invention is directed to a physical process causing the effect of preserving proteic food (seafood and various types of meat) throughout long periods of time, thereby preserving the properties of a fresh product, such as its color, smell, texture and taste. At the same time, with the abovementioned process it is possible to maintain the proteic and vitaminic contents of the original product.

### STATE OF THE ART

So far, the preservation of food with animal origin (whether from sea, river or earth animals) has been performed using physical, chemical or physicochemical agents, able to inhibit or avoid the proliferation of bacteria which causes decomposition of dead organic matter, simultaneously nullifying the action of fungi, bacteria and enzymes present in the field of organic decomposition. Nevertheless, the positive action of said agents has never been wide and effective enough as to definitely, or at least widely, avoid the presence of decomposition in meat food. Thus, for instance, the action of cold applied as ice over seafood, with or without disinfecting agents, and the bath or wash of beef or seafood with antiseptic solutions have not been able to fulfill the need of preservation with a greater extent and effectiveness with respect to the maintenance of optimal freshness conditions for human consumption, specially in an extended period of time or in long term. Moreover, known processes so far do not allow considering a treated product to remain within the characteristics of a fresh product after 2 years, as is the case of the invention herein revealed.

U.S. Pat. No. ES 2,114,503 B1 reveals a procedure to preserve fresh fish on a fishing boat based on the application of a variable condition atmosphere. In this process, the first stage is the storage of the captured fish within holds with airtight compartments, then subjecting the stored product to a cold stage, at a temperature between −1 and −1° C., and keeping said temperature throughout all the storage period. In the next stage, a gas composition determined based on different volumetric percentages of carbon dioxide (CO₂), oxygen (O₂) and nitrogen (N₂) is applied to the product, said percentages being previously determined as a function of time and according to the type of fish. There is also an atmosphere control stage and an atmosphere restoring stage 12 to 24 hours before the arrival of the boat into the port.

U.S. Pat. No. 4,396,636 reveals a method to produce frozen food based on the production of an ice coat around the meat during the first 15 minutes, using a temperature from −80 to −100° C.. Then, a mild freezing at temperatures of about −25 to −35° C. is performed to reach 0° C. at the center of the product. Afterwards, a fast freezing at −80 to −100° C. to reach a temperature of −6° C. or less at the center of the product is performed, and at last the product is frozen between −25 and −35° C. and is stored at −18 to −20° C. until consumed.

U.S. patent application No. CL 431/1986 reveals a method to preserve the texture and taste of seafood using thermal processing. To achieve this end, in addition to the thermal processing, the seafood, e.g. shrimp, is treated with a mixture of an aldonic acid and its lactones, therewith maintaining the texture and taste of seafood throughout said thermal processing, with no salt addition. Thus, in addition to seafood, the product also contains thermally processed gluconic acid.

U.S. Pat. No. 5,965,191 reveals a method to process fish which includes adding to the fish or spraying it with an alkaline agent.

The importance and main advantage that constitutes the difference between the abovementioned processes and the present invention is the absence in this invention of any kind of chemical compound or agent that could change the desirable properties of the product obtained at the end of the process, and so no other known process has the goal of obtaining a product (fish) with all the attributes of fresh food, after a long storage period under the conditions of the process of the present invention.

The judgment of renowned professionals on the nutrition field as well as experts on the packaging and culinary fields, which collaborated in the development of this project, allow predicting a definite possibility of extending the success obtained in the case of experiments with fish to other food, especially to any other type of meat.

### DESCRIPTION OF THE INVENTION

The object of this invention had as initial motivation the need of resolving aspects that condition fish commercialization from geographically remote places, such is the case of Chile, thus saving the economic feasibility of businesses of seafood exportation or distribution for human consumption, having at the same time a definite possibility to be extended to other fields in the food industry.

The process of this invention presents special economic and commercial advantages, mostly because it tends to bring a food product, intrinsically highly perishable, close to a consumer which is physically or chronologically remote, keeping its original quality. For instance, in the case of a commercial entity in the northern hemisphere receiving supplies from the southern hemisphere, said process would provide both the ability to optimize annual commercial operation cycles in its businesses and to capitalize the effects of the abovementioned process. These effects would consist basically in obtaining food with all the attributes of a fresh product, such as its original color, texture, smell and taste, after a long period of time.

Oriented by the inspection and research about the characteristics and requirements of European and North-American markets, namely France, Germany, Spain and Canada, and resulting from many long researches assessed by prestigious laboratories in Chile and abroad as well as by nutrition, culinary and packaging and vacuum techniques experts, the work invested in this invention has developed an improved industrial process which is not comparable in its effects with any known process so far, allowing the consumption of food such as “fresh fish” with its original organoleptic properties, even after tens of months from its capture or treatment.

The process of the invention consists generally in a physical and natural method that excludes chemical agents, and based on simple sub-processes, applied in specific sequences, giving as a result the preservation of food for many months, as registered in certificates issued by CESMEC laboratories at Santiago de Chile, where it could be assessed a “fresh-like” state after more than 2 years of preservation, with better color, smell, texture and taste properties as compared to those from equivalent food products usually commercialized with a “fresh quality” denomination.

The process of the invention is simple and comparatively economic. Its key feature lies on the way by which the product is manipulated and the sequence by which each specific stage or sub-process is performed, as well as on the characteristics of certain materials and equipment used in the process.

The process of the invention may be applied to fish and seafood, such as southern or European hake, common or gayi hake, sole, turbot, trout, salmon, jack or horse mackerel, conger eel, grouper or sea bass, meager, albacore (sword fish), scallop, abalone, limpet and the like, and it results to be highly competitive in northern hemisphere markets where these products are well known and commercialized.

The effects of preserving the food as fresh, which are the object of this invention, are obtained by subjecting the food products, “fish, seafood or meat”, to a simple, natural and effective combination of sub-processes consisting in the following sequence:
a) A quick initial freezing to reach −5° C. at the center of each piece.
b) An immediate high vacuum packing process using special materials with an outstandingly low permeability to gases and water vapor and at the same time resistant to handling and to a wide range of temperatures.
c) Continuing the quick freezing process to reach a temperature of −18° C. at the center of each piece.
d) Keeping the product in dark chambers with uniformly low temperatures around −18° C.
e) Unfreezing, unpacking and reverse processing the product.
   Process of the Invention Applied to Fish

Excellent results have been obtained in the case of proteic products of high perishability, such as fish, with respect to which long time experiment series have been developed in Puerto Montt, Santiago and the northern hemisphere (Europe and Canada), concerning both production and transport. These results have been certified in due time by CESMEC (Centro de Estudios, Medición y Certificación de Calidad; Center for Studies, Measuring and Quality Certification) laboratories, after more than two years after the products have been subjected to said process. Obviously, these processes are performed under strictly hygienic conditions.

Specifically, in the case of fish, the procedure has to be carried out as long as possible before the rigor mortis point, which is specified as a way to optimize the product in its “fresh quality”; notwithstanding the process is still valid without the fulfillment of this condition. The process is described as follows:

a. Extension of Rigor Mortis, or Application of the Process to a Fresh Product Post-Rigor Mortis

The fish is captured and immediately cleaned on the boat. To this end, the fish is selected, eviscerated and washed, and then put in chambers within boxes with scales of ice, in order to preserve it at a temperature as near as possible to 0° C.. Usually the fish is maintained in this state more than 2 and less than 24 hours (time required to cover the distances from within territorial sea limits to the coast), from its capture until the arrival to the processing plant.

Another embodiment of the invention considers that the process could be performed on board, if the facilities are arranged to this purpose. With this method, which consists in keeping the fish at low temperatures, rigor mortis is prolonged, which is the recommended state to cut meat into pieces or filets, before lactic acid is produced, preserving its texture and consistency, and avoiding post-rigor mortis flaccidity.

Notwithstanding that the abovementioned conditions optimize the degree of freshness of the treated product, the process of the invention is also valid when applied to a post-rigor mortis fresh product. The only resulting consequence is to obtain a product with a different degree of freshness.

b. Process of Preparation, Initial Quick Freezing, High Vacuum Packing and Complementary Quick Freezing

Once fish has been cut into pieces, filets, medallions, slices, “HG” (eviscerated and beheaded fish) and the like, it must be frozen quickly using a IQF (individual quick freezing) process and high vacuum packed, in agreement with the following steps.
i. A temperature of − 5° C. must be reached at the center of the meat piece, in a maximum of 1.5 hours.
ii. Using appropriate equipments, the meat piece must be immediately packed under high vacuum (99%), and adequately sealed.
iii The individual quick freezing process must be continued until reaching a temperature of −18° C. at the center of the meat piece in the next 2 hours, at most. In this way, a temperature of −18° C. must be reached at the center of the meat piece in a maximum of 3.5 hours, including the high vacuum packing time.

With this individual quick freezing process of the pieces, crystal formation is avoided in meat tissues, avoiding damages to its texture which could cause lack of consistency and degraded aspect. With said individual quick freezing and a prompt high vacuum packing at the intermediate stage, an original intact and natural meat preservation state is achieved, thus avoiding any damage to the cellular membrane and its potential dehydration, as well as a possible oxidation.

The high vacuum packing material consists in thermoformed bags or envelopes made with special materials which present a high permeability barrier, mainly for oxygen, carbon dioxide, nitrogen, water vapor and odorants. Such material could be coextruded laminated polyamide-polyethylene films with high barrier adhesives, such as EVO/EVAH. These materials are comparatively light, flexible and resistant, with low permeability to gases, water vapor and odorants, and high mechanical resistance, while able both to adapt to different forms and to be subjected to a wide temperature range with no damage.

The so packed product is protected from any contact with the environment, avoiding any possible microbial, liquid or odorant contamination during its storage, handling and selling. The absence of oxygen achieved throughout the vacuum sealing process avoids any possible oxidation, as well as, outstandingly, any dehydration process to which it could be exposed otherwise. Moreover, it is understood that the packing material restrain odors and flavors to be transmitted from and towards the food product, independently of the temperatures to which said product and package is subjected.

More specifically, in the following table the permeability parameters to be fulfilled by the packing materials are indicated:

| | | | Permeability | | |
|---|---|---|---|---|---|
| | | | to water | | |
| Permeability to gases | | | vapor (g/cm² - | | |
| (cm³/m² - 24 h, - bar, at 75% | | | 24 h at | Temper- | Sealing |
| relative humidity) | | | 20° C. - 85% | ature | temper- |
| | Carbonic | | relative | resistance | ature |
| Oxygen | anhydride | Nitrogen | humidity) | (° C.) | (° C.) |
| 4 to 10 | 12 to 30 | 1.3 to 5 | 0.1 to 0.6 | −60 | +130 |
| | | | | to +100 | to +200 |

c. Preservation

Industrially speaking, the product is stored in plastified cardboard boxes in order to protect it from light. These boxes are put into plastic boxes that can be piled up, or into equivalent storage systems, which are introduced into industrial freezing chambers, at uniform temperatures around − 18° C. Obviously, said procedure is also valid at domestic scale with small volumes stored in home freezers.

d. Use and Consumption

The treated product is removed from the chambers or freezers and is subjected to defrosting using a clean process to remove it from the vacuum package. For instance, the product is put into the butter chamber of a regular refrigerator, at temperatures between − 2 and +2° C., thus allowing obtaining of a fresher product than those usually referred to as “fresh”, while treating it like any other fresh product in such refrigerator chamber, ready to be consumed in 1 to 3 days.

Alternatively, the packaged product at − 18° C. may be put into a microwave oven for a few minutes, according to the size and shape of the fish piece, after which the package is opened and the product is ready to consume, with the characteristics of a highly fresh product.

The piece of fish may also be put directly in hot water for a few minutes, inside its package.

Similarly, the most diverse known culinary treatments could be applied as desired, as starting from a fresh piece of meat.

In summary, the subprocess sequence and the cumulative concurrence of the four stages (a) to (d) of the abovementioned total process, can be synthesized as follows:
Rigor mortis is prolonged or a fresh product is processed post rigor mortis.
The product is quick frozen in two stages, packing it after the first stage using a high vacuum sealing process in packages having a high degree of impermeability to gases and to water vapor.
Uniform temperatures around −18° C. are maintained.
An inverse process is applied, which consists in the following steps:
   Removing the product from its package using a normal defrosting process, or
   Cooking the food product in its package in a microwave oven or in hot water.

By this procedure, a high quality product is obtained which could be preserved in its original conditions and intact for periods of time exceeding 2 years, provided that it is kept packed and under high vacuum at uniform temperatures around −18° C.

### EXAMPLE OF APPLICATION

The abovementioned process was applied to filets of small southern hake, named “smurf”, taking advantage of its low price and the possibility to use them as “individual portions”. Samples of this product, treated according to the invention previously described, were taken to Europe (Spain, France and Germany) and Canada, where it raised great interest between commercializers of this product, such product being evaluated as a direct competence to the so-called “fresh” product, which is usually offered under this denomination after 6 to 8 days at MERCAMADRID (Madrid, Spain) or at RUNGIS (Paris, France).

After multiple tests, the experimental runs submitted to CESMEC laboratories were carried out in two periods as follows:

1.On March 1990, fresh small (“smurf”) European hake was purchased at the small fisher's port of Chinquihue, Puerto Montt, Chile. The product was transported to a fishing industry at Puerto Montt, where it was subjected to the following procedure:
i. Fish was eviscerated;
ii. Skin was removed from fish;
iii. Two filets of 150-200 grams each were produced from each fish;
iv. Filets were washed;
v. Said filets were subjected to a quick freezing process in a specially adapted freezing tunnel;
vi. Immediately after a temperature between − 18 and − 20° C. was reached in the center of the product, filets were packed in high vacuum bags;
vii. Bags were sealed with the product inside, using high vacuum (approximately 99%) produced by an appropriate MULTIVAC pump (Germany);
viii. Samples were stored in refrigerated chambers at constant temperatures of around −18° C..

A fraction of the previously described samples was carried to Europe on July in the same year, in coolers with dry ice, to be tested on a test market. The product obtained very good acceptance, especially in places of Spain far away from the coast (for instance, Zaragoza), which require fresh product that is not usually delivered in an adequate way.

A fraction of the same product was submitted on September in the same year to be analyzed in CESMEC laboratories at Santiago de Chile, said product achieving successful results when freshness quality was assessed, which was measured taking into account four parameters to define this status: color, smell, taste and texture, wherein said product obtained the following qualifications:

Organoleptic Assay

| | |
|---|---|
| Color: | *Typical |
| Smell: | *Typical |
| Taste: | *Typical |
| Texture: | Firm to pressure |

*Characteristic for the species

2. On October 1990 a second lot of product was prepared, in a completely analogous way as that described before in point 1 (i to viii), keeping it in adequate refrigerator chambers at uniform temperatures of about −18° C. until January 1993 (more than 2 years), when the same tests were applied at CESMEC laboratories, obtaining results that characterize a fresh product, measured under the same abovementioned standards, as follows:
Organoleptic Assay
Color: Normal condition for a fresh product
Smell: Characteristic for a fresh product
Taste: Characteristic and pleasant
Texture: Firm to pressure, good conservation state, humid (no water loss), pleasant in the mouth.

It should be noted that the high vacuum packaging process in the foregoing examples was carried out as the final step after the freezing process, when the center of the pieces was already at temperatures around −18° C.. Nevertheless, the industrial process is set forth in an optimized form wherein the high vacuum packing stage is performed after a first freezing stage, when the center of the pieces reaches a temperature around −5° C., thus avoiding at maximum any oxidation and dehydration process. Moreover, at present time different technologies are available allowing to achieve said both freezing stages in substantially less time than the specified maxima, which contributes efficiently to the optimization of the quality of the process and the invention.

1. A physical process causing the effect of preserving fish or meat food throughout long periods of time, tens of months, thus preserving the properties of a fresh product, wherein said process comprises the following steps:
a) Capturing, eviscerating, cleaning, and washing the fish, all in an hygienic environment;
b) Keeping said fish under moderate cold, using ice scales or adequate cold facilities;
c) Cutting the fish in agreement with the commercial requirements to be satisfied; d) Subjecting the fish to an initial quick freezing process, of the type IQF, thereby reaching a temperature of around −5° C. in the center of a fish piece in a maximum of 1.5 hours;
e) Packaging the product in special packages, which possess high impermeability to gases, basically oxygen, nitrogen and carbon anhydride, as well as to water vapor, and are at the same time highly resistant both to physical stress and to a wide range of temperatures from −60 to 100° C., even though they can endure sealing temperatures in the range form +130 to +200° C.;
f) Subjecting the packed product to a high vacuum process, wherein the high vacuum comprises a 99% vacuum;
g) Continuing the quick freezing of step (d) from around −5° C. to reach a temperature of around −18° C. in the center of a meat piece in a maximum of 2 hours including the packaging time;
h) Keeping the packed product at low and uniform temperatures around −18° C., in resistant plastified cardboard boxes, using pile-up systems if said boxes are not auto-supportive;
i) Using the treated product by taking it out from the freezing chambers or freezers and subjecting it to defrosting by a clean packing extraction process, preserving the product in a butter chamber of a refrigerator, ready to be consumed in 1 to 3 days by treating it as a fresh product;
j) Consuming the treated product in agreement with the user intentions, even subjecting it to cooking in a microwave oven or in hot water including the package.

2. A physical process causing the effect of preserving fish or meat food throughout long periods of time according to claim 1, wherein said package comprises materials which have a high impermeability to gases, water vapor, and many diverse type of odorants.

3. A physical process causing the effect of preserving fish or meat food throughout long periods of time according to claim 1, wherein said step (e) is carried out using facilities or equipments to produce high vacuum, using materials that fulfill the general requirements indicated in said step (e) of claim 1, wherein the permeabilities to gases, water vapor and temperature resistances should be located between the limits set forth in the following table:

| | | | Permeability | | |
|---|---|---|---|---|---|
| | | | to water | | |
| Permeability to gases | | | vapor (g/cm² - | | |
| (cm³/m² - 24 h, - bar, at 75% | | | 24 h at | Temper- | Sealing |
| relative humidity) | | | 20° C. - 85% | ature | temper- |
| | Carbonic | | relative | resistance | ature |
| Oxygen | anhydride | Nitrogen | humidity) | (° C.) | (° C.) |
| 4 to 10 | 12 to 30 | 1.3 to 5 | 1.0 to 1.6 | −60 | +130 |
| | | | | to +100 | to +200 |

4. A physical process causing the effect of preserving fish or meat food throughout long periods of time according to claim 1, wherein said step (e) uses materials that do no transmit odors and flavors independently of the temperatures to which they are subjected in this process; such materials being highly resistant, both to physical stress and to a wide range of temperatures; such materials being also flexible enough to be able to adapt to surfaces of diverse shapes and textures, including soft and sharp edges, in the context of typical requirements in a high vacuum process.

5. A physical process causing the effect of preserving fish or meat food throughout long periods of time according to claim 1, wherein said steps (d) to (g) are carried out together in a single ad hoc industrial facility, maintaining the specified sequence.
